(19) United States
(12) Patent Application Publication
(10) Pub. No.: US 2025/0289416 A1
(43) Pub. Date: Sep. 18, 2025

(54) VEHICLE CONTROL DEVICE AND STORAGE MEDIUM

(71) Applicant: TOYOTA JIDOSHA KABUSHIKI KAISHA, Toyota-shi (JP)

(72) Inventors: Hideyuki USUI, Inazawa-shi (JP); Tomoki NAGAO, Nagoya-shi (JP); Yoshiaki MORIYA, Toyota-shi (JP)

(73) Assignee: TOYOTA JIDOSHA KABUSHIKI KAISHA, Toyota-shi (JP)

(21) Appl. No.: 19/074,651

(22) Filed: Mar. 10, 2025

(30) Foreign Application Priority Data
Mar. 15, 2024 (JP) 2024-041371

(51) Int. Cl. B60W 30/08; B60W 30/095; B60W 50/00

(52) U.S. Cl. CPC B60W 30/08; B60W 30/0953; B60W 30/0956; B60W 50/0097; B60W 2030/082; B60W 2554/802

(57) ABSTRACT

A control unit that determines an attribute of an object in contact with a vehicle is provided to a vehicle control device, and the control unit recognizes an attribute of an object existing outside the vehicle based on a detection value that detects an environment around the vehicle, calculates a relative speed between the vehicle and the object, and determines that the vehicle and the object are in contact when an acceleration generated in the vehicle is within a range of a determination threshold value set based on a relationship between the relative speed and the acceleration.

### CROSS-REFERENCE TO RELATED APPLICATION

This application claims priority to Japanese Patent Application No. 2024-041371 filed on Mar. 15, 2024, incorporated herein by reference in its entirety.

### BACKGROUND

### 1. Technical Field

The disclosure relates to a vehicle control device and a storage medium for estimating an object coming into contact.

### 2. Description of Related Art

Japanese Unexamined Patent Application Publication No. 2020-169016 (JP 2020-169016 A) describes a collision detection device that detects a collision between a vulnerable road user, such as a pedestrian, a bicycle, or the like, and a vehicle, and reports the collision to an external entity. According to this collision detection device, an object is detected, acceleration of the vehicle is detected, a collision prediction timing of the object and the vehicle is calculated, and when detection timing at which acceleration exceeding a threshold value is detected and the collision prediction timing are at concurrent, determination is made that the vehicle and the object collided with each other.

### SUMMARY

According to technology described in JP 2020-169016 A, when the detection timing of the acceleration and the collision prediction timing are concurrent, determination is made that the vehicle and the object collided with each other. Accordingly, there is a possibility that an object that has actually collided and an object that has been detected are not the same, and there is a possibility of erroneously determining the object.

An object of the disclosure is to provide a vehicle control device and a storage medium capable of determining an attribute of an object at a time of contact.

One aspect of the disclosure is a vehicle control device, including
a control unit for determining an attribute of an object in contact with a vehicle, in which the control unit
recognizes the attribute of the object present outside the vehicle, based on a detection value regarding which an environment around the vehicle is detected,
calculates a relative speed of the vehicle and the object, and
determines that the vehicle and the object came into contact with each other, when acceleration generated in the vehicle is within a range of a determination threshold value set based on a relation between the relative speed and the acceleration.

According to the disclosure, an attribute of an object can be determined at a time of contact.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration of a vehicle according to an embodiment;

FIG. 2 is a diagram illustrating a configuration of a determination map; and

FIG. 3 is a flowchart illustrating a flow of processing of the vehicle control method executed in the vehicle control device.

### DETAILED DESCRIPTION OF EMBODIMENTS

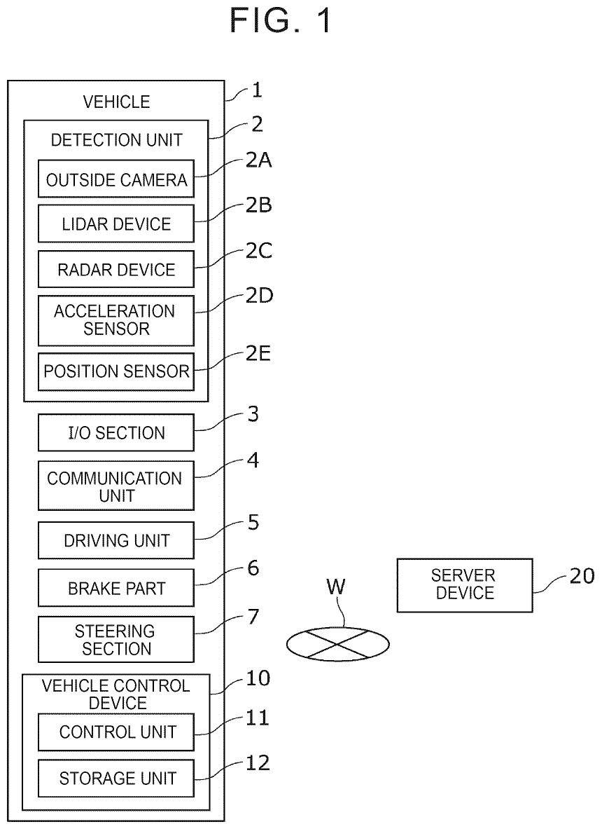

As illustrated in FIG. 1, the vehicle 1 includes, for example, a vehicle control device 10 that executes control related to traveling. The vehicle control device 10 controls the traveling of the vehicle 1 based on the operation of the driver. The vehicle control device 10 executes driver assistance control for assisting a driving operation on the basis of the detection value detected by the detection unit 2 that detects the detection value related to the traveling of the vehicle.

The detection unit 2 includes an outside-vehicle-camera 2A that captures an image of an external environment of the vehicle 1. The detection unit 2 may include one or more outside-vehicle 2A for capturing an image of a predetermined imaging area around the vehicle 1. The outside-vehicle-camera 2A generates an image of the surroundings of the vehicle 1 and outputs the image to the vehicle control device 10. The detection unit 2 includes a rider device 2B that measures the external environment of the vehicle 1. The rider device 2B measures the external environment of the vehicle 1 based on the laser beam, and acquires three-dimensional data of the environment around the vehicle 1 based on the light reception data of the reflected light. The rider device 2B outputs the detected value to the vehicle control device 10.

The detection unit 2 includes a radar device 2C that measures the external environment of the vehicle 1. The radar device 2C measures the external environment of the vehicle 1 based on microwaves, and measures the distance to an object existing around the vehicle 1 based on the reception data of the reflected waves. The radar device 2C outputs the detected data to the vehicle control device 10.

The detection unit 2 includes an acceleration sensor 2D that detects an acceleration generated in the vehicle 1. The acceleration sensor 2D is provided, for example, at a distal end portion of the vehicle 1. The acceleration sensor 2D detects an acceleration generated when the vehicle 1 and the object come into contact with each other in the unlikely event. The acceleration sensor 2D outputs the detected value to the vehicle control device 10. The detection unit 2 includes a position sensor 2E that detects the present position of the vehicle 1. The position sensor 2E is constituted by, for example, a sensor that detects three-dimensional coordinates of the vehicles 1 such as GPS (Global Positioning System). The position sensor 2E outputs the detected value to the vehicle control device 10.

The vehicle 1 includes an input/output unit 3 that receives an operation of an occupant and outputs information. The input/output unit 3 is constituted by, for example, a touch panel type display device such as a liquid crystal display. For example, the input/output unit 3 outputs information indicating that the driver assistance control is being executed to the occupant while the driver assistance control is being executed.

The vehicle 1 includes a communication unit 4 that can be communicatively connected to the network W. The communication unit 4 includes, for example, a wireless communication interface. The communication unit 4 is configured to transmit and receive information to and from the server device 20 via the network W. The server device 20 is configured as a monitoring server that monitors the travel of the vehicle 1. For example, when a certain situation occurs in the vehicle 1 and a notification is received from the vehicle control device 10, the server device 20 transmits a predetermined notification to the related organization.

The vehicle 1 includes a driving unit 5 that serves as a driving source during traveling. When the vehicle 1 is an internal combustion locomotive, the driving unit 5 is constituted by an internal combustion engine. When the vehicle 1 is a battery electric vehicle, the driving unit 5 is constituted by an electric motor. When the vehicle 1 is a hybrid electric vehicle, the driving unit 5 may be configured as a hybrid system in which an internal combustion engine and an electric motor are combined. The driving unit 5 is controlled by the vehicle control device 10 based on an input operation of the driver, and adjusts the acceleration and deceleration of the vehicle 1. When the driver assistance control is executed, the driving unit 5 is automatically controlled by the vehicle control device 10.

The vehicle 1 includes a braking unit 6 that controls braking during traveling. The braking unit 6 is constituted by, for example, a brake device. When the vehicle 1 is a battery electric vehicle or a hybrid electric vehicle, the braking unit 6 may be configured by the driving unit 5. The braking unit 6 is automatically controlled by the vehicle control device 10 when the driver assistance control is executed. The vehicle 1 is provided with a steering unit 7 that controls the direction in which the vehicle is traveling. The steering unit 7 includes, for example, a steering device that adjusts the angle of the steered wheels. The steering unit 7 may be configured by the driving unit 5 when the vehicles 1 are battery electric vehicle or hybrid electric vehicle. When the driver assistance control is executed, the steering unit 7 is automatically controlled by the vehicle control device 10.

The vehicle control device 10 includes a control unit 11 that determines contact between the vehicle 1 and an object based on the detection value detected by the detection unit 2 and executes driver assistance control. The control unit 11 is constituted by a hardware processor such as at least one CPU (Central Processing Unit). The vehicle control device 10 includes a storage unit 12 that stores data and programs necessary for control. The storage unit 12 includes a non-transitory storage medium such as a hard disk drive (HDD) or a solid state disk (SSD).

The control unit 11 determines whether or not an object exists around the vehicle 1 based on the detection value detected by the detection unit 2. For example, the control unit 11 determines whether or not there is an object present around the vehicle 1 based on the captured image of the outside-vehicle-camera 2A. For example, the control unit 11 is configured to execute machine learning such as deep learning in which imaging data is used as teacher data in advance, and to be able to recognize various objects from the imaging data.

When determining that an object exists based on the imaging data, the control unit 11 recognizes the attribute of the object. For example, the control unit 11 recognizes an attribute of an object including a traffic participant such as an automobile (also referred to as another vehicle), a motorcycle, a bicycle, or a pedestrian included in the imaging data based on the imaging data. The relative speed between the vehicle and the object is calculated. The control unit 11 calculates a distance d between the vehicle 1 and the 10 object based on the detected values of the rider device 2B and the radar device 2C.

The control unit 11 determines whether or not the vehicle 1 and the object are approaching based on the traveling direction of the vehicle 1 and the degree of decrease over time in the distance d between the vehicle 1 and the object. When determining that the vehicle 1 and the object are approaching each other, the control unit 11 calculates a distance between the vehicle and the object after the lapse of the unit time, and calculates a relative speed Vr between the vehicle 1 and the object based on the calculation result.

The control unit 11 calculates a Time-To-Collision (TTC) until the vehicle 1 collides with the object on the basis of the distance d between the vehicle 1 and the object and the relative speed Vr. The control unit 11 calculates TTC based on the distance d between the vehicle 1 and the object, the relative speed Vr, and the following expression (1).

$$TTC = d / Vr \qquad ( 1 )$$

The control unit 11 continuously calculates TTC and compares TTC with threshold values (TTCref). The control unit 11 continuously calculates TTC. When TTC becomes less than or equal to the threshold value, the control unit 11 starts a timer and starts measuring the time (t). For example, when TTC becomes less than or equal to the threshold value, the control unit 11 stops outputting the driving unit 5 and controls the braking unit 6 to execute driver assistance control for automatically decelerating the vehicle 1. For example, when TTC becomes equal to or less than the threshold value, the control unit 11 controls the steering unit 7 to execute driver assistance control for avoiding the vehicle 1 from the target object. The control unit 11 monitors the acceleration Gf detected by the acceleration sensor 2D after the timer is started. When the acceleration Gf is detected, the control unit 11 determines whether or not the object and the vehicle 1 have contacted each other.

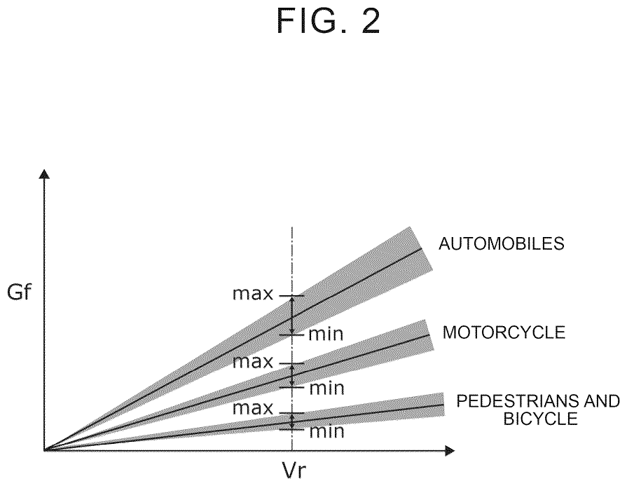

FIG. 2 illustrates a determination map set based on the relationship between the relative speed and the acceleration. The magnitude of the acceleration Gf generated when the vehicle 1 and the object come into contact with each other varies depending on various factors such as the mass/rigidity/structure of both vehicles, the relative speed at the time of collision, the collision position/lap ratio, and the presence or absence of peripheral components. Therefore, an attribute of object touching the vehicle 1 is not uniquely determined based on the magnitude of the acceleration Gf. However, the acceleration generated at the time of contact between the pedestrian and the vehicle 1 and the acceleration generated at the time of contact between the vehicle and the vehicle 1 are clearly different due to the mass difference between the pedestrian and the vehicle.

In the determination map, a range of a determination threshold value in which an upper limit value (Gfrefmax) and a lower limit value (Gfrefmin) are determined in the threshold value Gfref of the acceleration Gf for each attribute of the object is set in advance. In the determination map, the lower limit value of the acceleration Gf may be set as 0 G, and the determination threshold value range of only the upper limit value may be set. In the determination map, for example, determination threshold values are individually set according to a plurality of attributes. In the illustrated example, three decision threshold values are shown depending on the attributes of three objects: automobile, motorcycle, pedestrian, and bicycle. The setting of the determination map shown in the figure is an example, and may be configured by a setting different from the exemplified setting as long as the relationship between the acceleration and the object can be determined.

For example, in the determination map, when the relative speed between the vehicle 1 and the object is Vr, three determination threshold values are determined for the acceleration. When the relative speed is Vr and the acceleration Gf is detected, the control unit 11 refers to the determination map and determines the attribute of the object touching the vehicle. When the acceleration Gf generated in the vehicle 1 is within the determination threshold values corresponding to the predetermined attributes, the control unit 11 determines that the vehicle 1 and the predetermined object have contacted each other.

The control unit 11 refers to the determination map, and determines that the vehicle 1 and the pedestrian have contacted each other when the acceleration Gf generated in the vehicle 1 is within the determination threshold values corresponding to the pedestrian attributes. The control unit 11 refers to the determination map, and determines that the vehicle 1 and the two-wheeled vehicle have contacted each other when the acceleration Gf generated in the vehicle 1 is within the determination threshold values corresponding to the attributes of the two-wheeled vehicle. The control unit 11 refers to the determination map, and determines that the vehicle 1 and the vehicle have contacted each other when the acceleration Gf generated in the vehicle 1 is within the determination threshold values corresponding to the attributes of the vehicle.

For example, the control unit 11 recognizes the attribute of the object based on the captured image data, and refers to the determination map when the acceleration Gf and the relative speed Vr are acquired, and sets the determination threshold values for the acceleration Gf according to the recognized attribute. The control unit 11 compares the elapsed time t from the starting time of the timer with TTC when the determination threshold value of the attribute recognized by the acceleration Gf is within the range.

For example, the control unit 11 determines whether or not the elapsed time t substantially matches TTC based on the determination expression (2) including the error tolerance a set in view of the effects of the measured error, the calculation error, the variation of the vehicle condition, and the like.

$$( T T C - α ) \leq t \leq ( T T C + α ) \qquad ( 2 )$$

When the elapsed time t is within the range of the determination expression (2), the control unit 11 determines that the vehicle 1 and the target object are in contact with each other. In a case where it is determined that the vehicle is in contact with the object, the control unit 11 executes the vehicle support control according to the attribute. When it is estimated that the attribute of the object is a vulnerable road user such as a pedestrian, the control unit 11 executes driver assistance control for protecting the vulnerable road user. The control unit 11 transmits a predetermined notification to the server device 20, for example, in a case where it is determined that the vehicle 1 and the vulnerable road user person come into contact with each other. When receiving the predetermined notification, the server device 20 notifies the related institution and performs an ambulance arrangement or the like.

For example, when it is determined that the vehicle 1 is in contact with the vulnerable road user person, the control unit 11 executes driver assistance control such as control for activating an outside airbag (not shown) for protecting the vulnerable road user person, control for popping up the hood, and the like. When it is determined that the vehicle 1 and the vehicle are in contact with each other, the control unit 11 executes driver assistance control such as activation of an in-vehicle airbag (not shown) for protecting the occupant and control for increasing the degree of tension of the seat belt. The control unit 11 transmits a predetermined notification to the server device 20. When receiving a predetermined notification, the server device 20 notifies a related organization such as the police.

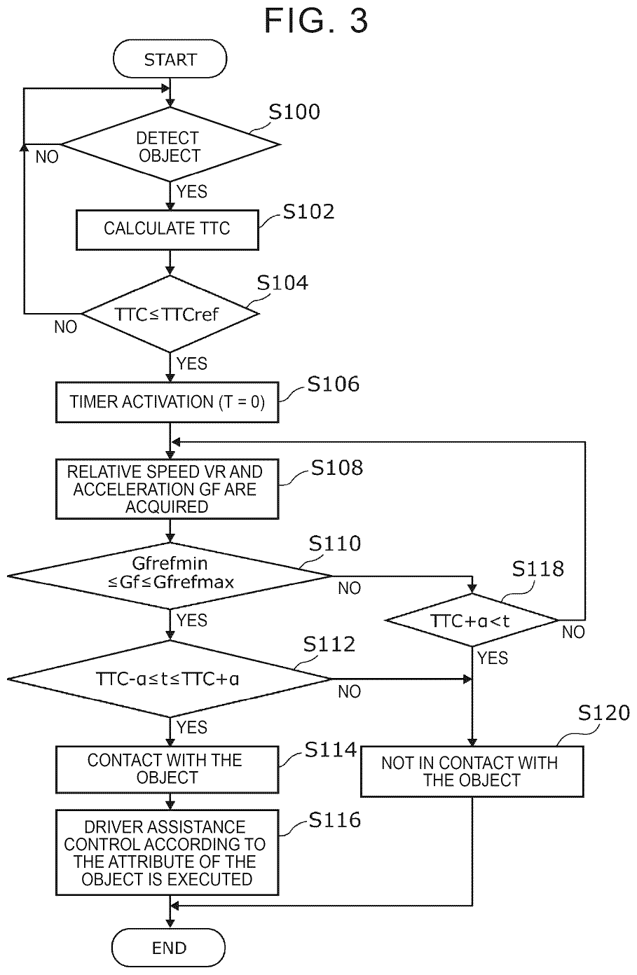

FIG. 3 is a flowchart illustrating a process flow of a vehicle control method executed in the vehicle control device 10. The vehicle control method is executed based on a computer program installed in the vehicle control device 10. The computer program causes the vehicle control device 10 to execute the following processing.

The control unit 11 determines whether or not an object exists in front of the traveling vehicle 1 based on the detection value detected by the detection unit 2 (S100). The control unit 11 also determines the attribute of the object based on the detected value. When the object is recognized, the control unit 11 calculates the relative speed Vr between the object and the vehicle 1, and calculates the Time-To-Collision TTC of the vehicle 1 based on the detected value of the relative distance between the object and the vehicle 1 and the calculated relative speed (S102). TTC is continuously calculated, and TTC is compared with a threshold value (TTCref) to determine whether or not TTC is equal to or less than the threshold value (S104). If it is determined that TTC is equal to or less than the threshold value, the control unit 11 starts a timer and starts measuring the time (t) (S106). The control unit 11 acquires a calculated value of the relative speed Vr and a detected value of the acceleration Gf (S108).

The control unit 11 refers to the determination map and determines whether or not the acceleration Gf generated in the vehicle 1 is within the determination threshold values corresponding to the attributes of the recognized object (S110). The control unit 11 determines whether or not the elapsed time t substantially matches TTC based on the determination expression (2) including the error allowable value a when the acceleration Gf is within the determination threshold value corresponding to the attribute of the recognized object (S112). When the elapsed time t and TTC substantially coincide with each other, the control unit 11 determines that the vehicle 1 and the recognized object have contacted each other (S114).

When it is determined that the object is touched, the control unit 11 executes the vehicle support control according to the attribute (S116). When the control unit 11 determines in S110 that the acceleration Gf generated in the vehicle 1 is not within the determination threshold value corresponding to the attribute of the recognized object, it determines whether or not TTC exceeds the determination threshold value (S118). When TTC does not exceed the determination threshold values, the control unit 11 returns the process to S108. When TTC exceeds the determination threshold values, the control unit 11 determines that the vehicle 1 does not touch the recognized object (S120).

As described above, according to the vehicle control device 10, the determination map is referred to, and the magnitude of the detected acceleration Gf is evaluated, determining the attribute of the object when in contact. According to the vehicle control device 10, it is possible to determine whether or not the attribute of the recognized object matches the attribute of the touched object, and it is possible to reduce the determination error of the contact with the object.

In the above-described embodiment, the computer program executed in each configuration of the vehicle control device 10 may be provided in a form recorded on a computer-readable portable non-transitory recording medium such as a semiconductor memory, a magnetic recording medium, or an optical recording medium.

What is claimed is:

1. A vehicle control device, comprising a control unit for determining an attribute of an object in contact with a vehicle, wherein the control unit
recognizes the attribute of the object present outside the vehicle, based on a detection value regarding which an environment around the vehicle is detected,
calculates a relative speed of the vehicle and the object, and
determines that the vehicle and the object came into contact with each other, when acceleration generated in the vehicle is within a range of a determination threshold value set based on a relation between the relative speed and the acceleration.

2. The vehicle control device according to claim 1, wherein, when determination is made that the vehicle came into contact with the object, the control unit executes driver assistance control in accordance with the attribute.

3. The vehicle control device according to claim 1, wherein the control unit
sets the range of the determination threshold value for the acceleration in accordance with the attribute that is recognized, and
determines that the vehicle and the object came into contact with each other, when the acceleration is within the range of the determination threshold value.

4. The vehicle control device according to claim 3, wherein, when the attribute is estimated to be a vulnerable road user, the control unit executes driver assistance control for protecting the vulnerable road user.

5. A non-transitory storage medium storing a program, installed in a computer that is installed in a vehicle control device for determining an attribute of an object in contact with a vehicle, the program causing the computer to execute processing of
recognizing the attribute of the object present outside the vehicle, based on a detection value regarding which an environment around the vehicle is detected,
calculating a relative speed of the vehicle and the object, and
determining that the vehicle and the object came into contact with each other, when acceleration generated in the vehicle is within a range of a determination threshold value set based on a relation between the relative speed and the acceleration.
